(19) United States
(12) Patent Application Publication
(10) Pub. No.: US 2023/0323777 A1
(43) Pub. Date: Oct. 12, 2023

(54) GUIDE VANE ASSEMBLY FOR A TURBOMACHINE, COMPRESSOR MODULE, TURBOMACHINE, AND METHOD FOR PRODUCING A GUIDE VANE ASSEMBLY

(71) Applicant: MTU Aero Engines AG, München (DE)

(72) Inventors: Ralf Stolle, Wolfratshausen (DE); Andreas Hölzel, Herrsching (DE); Romain Mandard, Petershausen (DE)

(73) Assignee: MTU Aero Engines AG, München (DE)

(21) Appl. No.: 18/006,147

(22) PCT Filed: Jul. 19, 2021
(86) PCT No.: PCT/DE2021/100626

§ 371 Date: Jan. 20, 2023

(30) Foreign Application Priority Data
Jul. 21, 2020 (DE) 10 2020 209 085.8

(51) Int. Cl. F01D 5/28

(52) U.S. Cl. CPC F01D 5/288; F05D 2230/90; F05D 2300/611

(57) ABSTRACT

The invention relates to a guide vane assembly for a turbomachine, comprising a guide vane, which has a guide vane airfoil; and a guide vane holder. The guide vane is mounted in the guide vane holder such that the guide vane can be moved about an axis of rotation. For this purpose, the guide vane has at least one axle element, which is inserted into the guide vane holder in such a way that an outer lateral surface of the axle element faces an inner lateral surface of the guide vane holder. A protective coating is applied to at least parts of the guide vane airfoil. A protective coating is applied to at least one of the lateral surfaces. The invention also relates to a compressor module, a turbomachine, and a method for producing a guide vane assembly.

### BACKGROUND OF THE INVENTION

The present invention relates to a guide vane assembly for a turbomachine.

The turbomachine may involve, for example, a jet engine, e.g., a turbofan engine. Functionally, turbomachines are divided into compressor, combustion chamber, and turbine. That is, in the case of the jet engine, intake air is compressed by the compressor and burned in the downstream combustion chamber with kerosene mixed in. The hot gas that arises, a mixture of combustion gas and air, flows through the downstream turbine and is thus expanded. In this case, the turbine withdraws the hot gas, energy also proportionally, in order to drive the compressor.

The present subject can relate to the compressor region in particular, but in general, for example, can also find use in the turbine. Likewise, the reference to the aircraft engine shall illustrate an advantageous field of application, but the subject is not at all limited in regard to its generality.

### SUMMARY OF THE INVENTION

The technical problem of the present invention is based on presenting an advantageous guide vane assembly for a turbomachine.

The latter problem is solved by the guide vane assembly according to the present invention. For changing the inflow angle, this assembly has a guide vane that is mounted in an adjustable manner in a guide vane holder via an axle element. In this mount, an outer lateral surface of the axle element is facing an inner lateral surface of the guide vane holder. Further, according to the present subject, at least one of these lateral surfaces is provided with a protective coating, and the guide vane airfoil is also provided with a protective coating, at least in regions.

The protective coating of the at least one lateral surface can prevent wear, for example, particularly in the case of a bushless configuration (without another mounting element between the lateral surfaces). In other words, the protective coating in the mount can make possible a direct contact between axle element and guide vane holder, which permits, for example, smaller structural sizes and/or shapes. For example, the guide vane ring can be made smaller in absolute dimensions and/or a smaller dividing ratio can be selected, both of which offer room for play in their design. The lateral surface(s) can be coated in regions or coated completely. According to a preferred embodiment, the guide vane holder can therefore be formed as a recess or drill hole in a housing segment of a compressor, said recess or drill hole being designed to hold the axle element in direct contact and to mount it rotatably.

In this case, by additionally also providing the guide vane airfoil with a protective coating, for example, the cost of production can be limited. Even in the case of a multilayer protective layer system, the protective coatings can have, for example, at least one layer in common, which can simplify application (with respect to throughput, and, e.g., also any possible cost for adding another coating; see below in detail). In functional terms, the protective coating of the vane airfoil can also prevent wear, for example, erosion. Since both the guide vane airfoil as well as also the at least one lateral surface has a protective coating, in both respects the service lives can be prolonged, and thus maintenance intervals can advantageously be adapted to the greater longevity.

Preferred embodiments are found in the dependent claims and in the overall disclosure, wherein, in the presentation of the features, there is not always a distinction made individually between device, method, and/or use aspects; in any case, the disclosure is to be read implicitly with respect to all claim categories. Without express indication to the contrary, “axially”, “radially” and “circumferentially”, as well as the respective directions, refer to the longitudinal axis of the turbomachine and not to the rotational axis and/or adjusted axis of the guide vane.

As discussed individually in the following, the axle element may be, for example, a journal or a shaft of the guide vane. The adjusted angle, i.e., the inflow angle, is adjusted via the shaft. The journal that is radially opposite when referred to the longitudinal axis of the turbomachine serves for suspension. Preferably, the guide vane assembly is designed without a bush both either on the journal or on the shaft; thus, the journal and the journal-guide vane holder are directly next to one another and the shaft and the shaft-guide vane holder are also directly adjacent to one another. It is preferred that the holder is provided with a protective coating on at least one of the lateral surfaces. The variants described below are also to be understood always as based on such a configuration, even when reference is only made generically to the guide vane holder and the axle element.

According to a preferred embodiment, the at least one lateral surface and the guide vane airfoil are coated identically with protective coating. Thus, the protective coatings have, for example, the same structure and/or the same material composition, and, in particular, they can be made with the same thickness. With identical protective coatings, for example, an extensive simplification in manufacture can be achieved, which can introduce the layers or the layer systems, in particular, simultaneously (which saves time and expense).

According to a preferred embodiment, the protective coating of the at least one lateral surface is applied both onto the axle element as well as onto the guide vane holder; i.e., in other words, both lateral surfaces receive the protective coating. Alternatively, for example, only the outer lateral surface can be provided with the protective coating and the inner lateral surface can remain uncoated.

Independently of whether the inner lateral surface of the guide vane holder is additionally coated or not, according to a preferred embodiment, the entire guide vane can be provided with protective coating. This may further simplify production; for example, no additional covering, etc. is necessary. Alternatively, for coating the axle element, the coating of the at least one lateral surface also can be achieved in general, however, by a coating of the guide vane holder alone. Therefore, in other words, the inner lateral surface can be coated exclusively, and the outer lateral surface can remain uncoated.

As already mentioned, a particular protective coating can also be applied in multiple layers, i.e., in at least two layers applied one on top of the other. Alternatively, however, it may also be a single-layer system; the protective coating can therefore also be composed of a single layer. The layers discussed below shall be disclosed both as part of a multilayer system as well as a respective single-layer system. Further, the options for depositing layers shall also be disclosed explicitly below with respect to production processes.

According to a preferred embodiment, at least one of the protective coatings has a galvanic layer or it is composed of a galvanic layer. For example, the galvanic layer may be a chromium layer, e.g., hard chrome, or a nickel layer. Alternatively or additionally, at least one of the protective coatings can be a chemical layer, e.g. chemical (electroless) nickel or nickel phosphorus (NiP).

According to a preferred embodiment, which shall be disclosed in turn both with respect to a multilayer system as well as to a single-layer system, is to provide a layer deposited from the vapor phase. For example, the layer can be applied via chemical vapor deposition (CVD), in particular also via plasma-assisted chemical vapor deposition (PACVD), or also via physical vapor deposition (PVD). For example, a PVD/PACVD carbon layer or layers is or are possible, e.g., a metal-containing, hydrogen-containing, amorphous carbon layer or layers a-C:H:Me. By doping with metal, for example, a compound with an a-C:H matrix containing metal carbides can be formed. One possible example is a tungsten carbide/carbon layer (WC/C), and likewise, a titanium carbide layer (Ti/C) or a tantalum carbide layer (Ta/C) or a DLC (diamond-like carbon) layer is possible. Also possible are hard material layers, for example, composed of titanium nitride (TiN), titanium carbonitride (TiCN), titanium aluminum nitride (TiAlN) or chromium nitride (CrN). Further a metal nitride/metal multilayer system, e.g., under the trademark ERCoat may also be provided.

According to a preferred embodiment, which can refer in turn to either a multilayer system or a single-layer system, a thermally sprayed layer is provided. For example, it can be a tungsten carbide layer, e.g. WC/Co. Further, for example, an alloy is also possible, e.g., a cobalt-chromium-molybdenum alloy (e.g., commercially available as Triballoy T-800).

According to a preferred embodiment, the axle element is a journal, which lies radially inside when referred to the longitudinal axis of the turbomachine. In an alternatively preferred embodiment, the axle element is a shaft, which lies radially outside when referred to the longitudinal axis of the turbomachine, and by which, the adjustment angle of the guide vane is predefined. As mentioned initially, it is preferred that both the journal as well as the shaft are designed bushless/without mounting element, so that when referred to the longitudinal axis, both the radially inner mount as well as the radially outer mount are each designed with at least one coated lateral surface.

The invention also relates to a compressor module having a guide vane assembly as disclosed in the present document. Further, the invention relates to a turbomachine, in particular an aircraft engine, having such a compressor module and/or a guide vane assembly as presently disclosed.

The invention further relates to a method for producing a presently disclosed guide vane assembly and/or the corresponding compressor module/turbomachine, wherein the protective coatings are applied, at least in regions, onto the guide vane airfoil and onto at least one of the lateral surfaces. Regarding possible details, reference is expressly made to the foregoing disclosure, in particular with respect to possible coating and deposition methods.

In a preferred configuration, the axle element, i.e., the outer lateral surface, and the guide vane airfoil receive a protective coating at the same time, i.e., in the same process. In this case, the coating of the guide vane airfoil is produced in regions (e.g., defined at the leading edge by a corresponding covering). It is preferred, however, that the guide vane airfoil is coated in its entirety; particularly the entire guide vane is coated.

### BRIEF DESCRIPTION OF THE DRAWINGS

The invention will be explained in more detail in the following on the basis of an example of embodiment, wherein the individual features in the scope of the independent claims can also be essential to the invention in other combinations, and wherein also no distinction is made individually between the different claim categories.

Taken individually,

FIG. 1 shows a schematic view of a turbofan engine in a longitudinal section;

FIG. 2 shows a guide vane assembly according to the invention;

FIG. 3 shows a view of a detail of FIG. 2.

### DESCRIPTION OF THE INVENTION

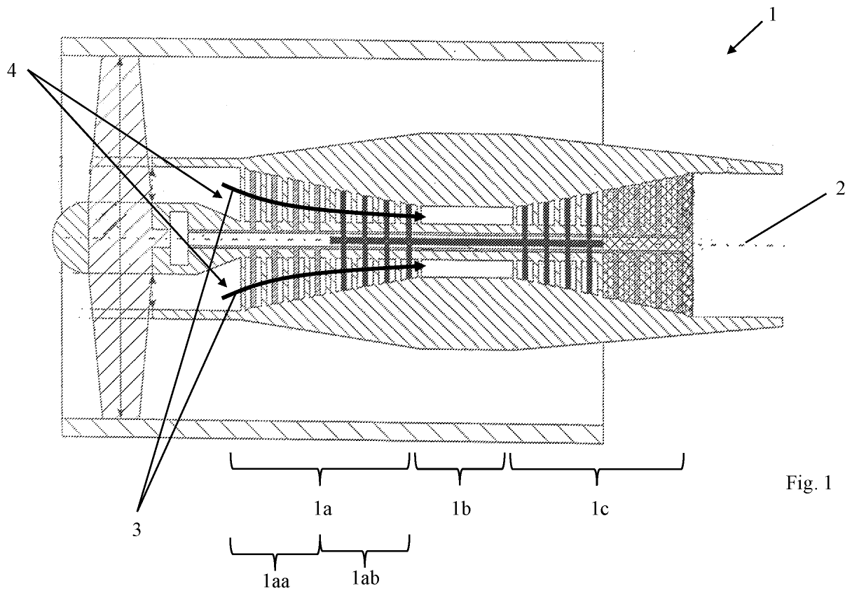

FIG. 1 shows a turbomachine 1 in section, specifically a jet engine (turbofan engine). The turbomachine 1 is functionally divided into a compressor 1a, a combustion chamber 1b and a turbine 1c. Both the compressor 1a and the turbine 1c are each constructed from several modules; the compressor 1a is presently composed of a low-pressure compressor module 1aa and a high-pressure compressor module lab. Each compressor module 1aa, lab is in turn constructed from a plurality of stages; each stage is usually composed of a rotating blade ring and a guide vane ring following thereon. During operation, with reference to a longitudinal axis 2, the compressor gas 3, air in the present case, flows through the compressor 1a axially, and does so in a compressor gas channel 4. In this way, the compressor gas 3 is compressed, then kerosene is mixed with it in the combustion chamber 1b, and this mixture is combusted.

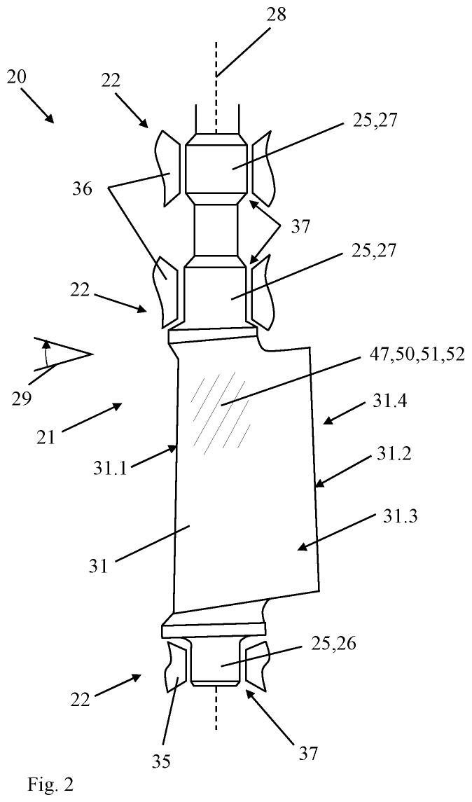

FIG. 2 shows a guide vane assembly 20 having a guide vane 21 and guide vane holders 22. The guide vane 21 comprises a guide vane airfoil 31, the latter having a leading edge 31.1 and a trailing edge 31.2, as well as two lateral surfaces 31.3, 31.4 that join together the leading edge 31.1 and the trailing edge 31.2. Further, the guide vane 21 has two axle elements 25, namely a radially inner journal 26 and a radially outer shaft 27. In this mounting arrangement, the guide vane 21 is rotatable about an axis 28, so that an inflow angle 29 of the guide vane airfoil 31 can be changed (perpendicular to the plane of the drawing).

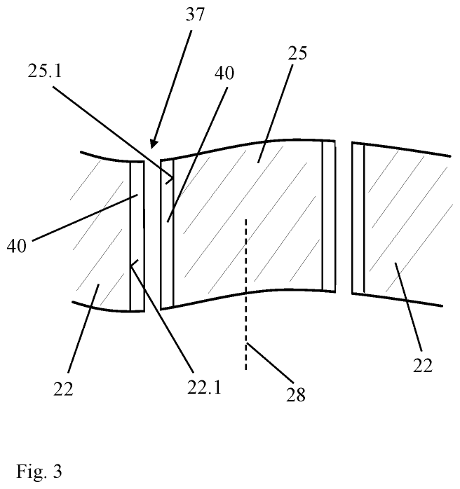

For example, the radially inner guide vane holder 22 can be formed in a mounting ring 35; in this example, radially outwardly, the shaft 27 is guided in two mounting rings 36. As can be seen from FIG. 2 and discussed in detail based on FIG. 3, the mounting arrangement of the axle element 25 both radially inside as well as radially outside is configured in a bushless manner; the axle elements 25 are each inserted directly into the respective holder 22. This is achieved by protective coatings 37 in the appropriate regions.

FIG. 3 shows such a protective coating 37 in detail. A section is shown wherein the sectional plane lies parallel to the axis of rotation 28 of the guide vane airfoil 21. The axle element 25 can be the journal 26 or the shaft 27. An outer lateral surface 25.1 of the axial element 25 is facing an inner lateral surface 22.1 of the holder 22. In the example shown, the holder 22 is designed without a bush, i.e., the holder does not have a slide mounting bush, but is formed directly by a recess/drill hole in a housing part. In a section lying horizontally and perpendicular to the plane of the drawing, the two lateral surfaces 25.1, 22.1 are each of circular shape.

The figure illustrates the protective coating 37; a protective layer 40 is introduced presently on the outer lateral surface 25.1, and a protective layer 40 is also introduced onto the inner lateral surface 22.1. During operation, the components rub against one another via these protective layers 40 (for the sake of clarity in the present case, a gap is depicted therebetween), the protective layers thus preventing wear. Alternatively, the inner lateral surface 22.1 may also be provided exclusively with the protective layer 40 or the outer lateral surface 25.1 may also be provided exclusively with the protective layer 40.

As can be seen from FIG. 2, the guide vane airfoil 21 is also provided with a protective coating 47. For reasons of clarity, this coating is only shown in regions, but in the present example, it extends over the entire guide vane airfoil 21. The protective coating 47, like the protective coating 37, can be composed of a galvanic layer 50, a layer 51 deposited from the vapor phase, and/or a thermally sprayed layer 52, for example. In one variant, the guide vane airfoil 21 and the axle elements 25 have an identical protective coating; in particular, the entire guide vane 21 can possess the same protective coating.

1. A guide vane assembly for a turbomachine, comprising
a guide vane having a guide vane airfoil, and
a guide vane holder, in which the guide vane is mounted adjustably about an axis of rotation,
for which reason, the guide vane has at least one axle element that is inserted in the guide vane holder in such a way that an outer lateral surface of the axial element is facing an inner lateral surface of the guide vane holder,
wherein a protective coating is applied onto the guide vane airfoil, at least in regions,
and wherein a protective coating is applied onto at least one of the lateral surfaces.

2. The guide vane assembly according to claim 1, wherein the protective coatings of the guide vane airfoil and the at least one lateral surface are identical.

3. The guide vane assembly according to claim 1, wherein the protective coating of the at least one lateral surface is applied onto the inner and the outer lateral surfaces.

4. The guide vane assembly according to claim 1, wherein the protective coating of the at least one lateral surface is applied exclusively onto the inner lateral surface.

5. The guide vane assembly according to claim 2, wherein the protective coating of the at least one lateral surface is applied onto the inner and the outer lateral surfaces and in which the entire guide vane is provided with a protective coating.

6. The guide vane assembly according to claim 1, wherein the protective coating of the at least one lateral surface is applied exclusively onto the outer lateral surface.

7. The guide vane assembly according to claim 1, wherein at least one of the protective coatings has a galvanic or chemical layer, or in which at least one of the protective coatings has a layer deposited from the vapor phase.

8. The guide vane assembly according to claim 1, wherein at least one of the protective coatings has a thermally sprayed layer.

9. The guide vane assembly according to claim 1, wherein the guide vane holder is a recess in a housing segment and the axle element is bushless and being configured and arranged to be mounted in direct contact in the guide vane holder.

10. The guide vane assembly according to claim 1, wherein the axle element is a journal, which lies radially inside when referred to a longitudinal axis of the turbomachine.

11. The guide vane assembly according to claim 1, wherein the axle element is a shaft, which lies radially outside when referred to a longitudinal axis of the turbomachine.

12. A compressor module having at least one housing segment, wherein at least one guide vane holder is formed, as well as a guide vane assembly according to claim 1.

13. A turbomachine, having a compressor module according to claim 12.

14. A method for producing a guide vane assembly according to claim 1,
wherein the protective coating is applied, at least in regions, onto the guide vane airfoil,
and wherein the protective coating is applied onto at least one of the lateral surfaces.

15. The method according to claim 14, wherein the protective coating is applied onto the outer lateral surface, and is done simultaneously with the application of the protective coating onto the guide vane airfoil.

16. The guide vane assembly according to claim 2, wherein the protective coating of the at least one lateral surface is applied exclusively onto the inner lateral surface and the entire guide vane is provided with a protective coating.

17. The turbomachine according to claim 13, wherein the turbomachine is an aircraft engine.

18. A method for producing a guide vane assembly according to a compressor module according to claim 12,
wherein the protective coating is applied, at least in regions, onto the guide vane airfoil,
and wherein the protective coating is applied onto at least one of the lateral surfaces.

19. A method for producing a guide vane assembly according a turbomachine according to claim 13,
wherein the protective coating is applied, at least in regions, onto the guide vane airfoil,
and wherein the protective coating is applied onto at least one of the lateral surfaces.
